(19) United States
(12) Patent Application Publication
(10) Pub. No.: US 2014/0286729 A1
(43) Pub. Date: Sep. 25, 2014

(54) TAPPING SCREW

(71) Applicants: Shingo Torii, Ayabe (JP); Naoki Nishimura, Ayabe (JP); Shinichi Hamano, Ayabe (JP)

(72) Inventors: Shingo Torii, Ayabe (JP); Naoki Nishimura, Ayabe (JP); Shinichi Hamano, Ayabe (JP)

(21) Appl. No.: 13/261,906

(22) PCT Filed: Nov. 30, 2011
(86) PCT No.: PCT/JP2011/077649

§ 371 Date: May 29, 2014

(51) Int. Cl. F16B 33/02

(52) U.S. Cl. CPC F16B 33/02
USPC 411/415

(57) ABSTRACT

There is provided a tapping screw having a high anti-loosening effect and a high pull-out resistance for resin-molded components. A tapping screw 1 according to the present invention is configured such that an intersection P between a root 10 and a clearance flank 8 of a thread 7 is set such that a first engaging rate ρ1 exceeds 50%, the first engaging rate ρ1 being percentage of an actual engaging height H1 to a hole 6 against a first thread height H2 from a crest of the, thread 7 to the intersection P, an intersection Q between the root 10 and a pressure flank 9 of the thread 7 is set such that a second engaging rate ρ2 is smaller than the first engaging rate ρ1 and no smaller than 50%, the second engaging rate ρ2 being percentage of the actual engaging height H1 to the hole 6 against a second thread height H3 from the crest of the thread 7 to the intersection Q, and the root of the thread inclines downward toward a tip direction, extending from the intersection P to the intersection Q thus set. By setting the first engaging rate ρ1 and the second engaging rate ρ2 in this manner, the root 10 inclining downward toward the tip direction provides a high pull-out resistance and a high anti-loosening effect.

### TECHNICAL FIELD

The present invention relates, to a tapping screw used for fastening resin-molded components.

### BACKGROUND ART

Recently, resin-molded components have been widely used due to their lightweight properties, reproductive properties, workability, and such. Thus, a tapping screw specific to fastening of resin-molded components as disclosed in Patent Document 1 has been contrived. This tapping screw is configured to realize fastening of resin-molded components with low durability and strength by providing its thread at a compound angle and its root between adjacent parts of the thread to be inclined downward toward a tip direction.

### PRIOR ART DOCUMENTS

### Patent Documents

Patent Document 1: Japanese Patent No. 2944660

### SUMMARY OF THE INVENTION

### Problems to be Solved by the Invention

Unfortunately, as the above tapping screw is specially-shaped, its optimal dimension regarding a thread height and an inclination angle of the root is unknown, and effects of the root inclining downward toward a tip direction are not fully exerted.

### Solutions to the Problems

A tapping screw according to the present invention is contrived, in view of the above problem, and includes: a shaft part having a thread therearound and configured to be screwed into a hole formed in a workpiece while forming an internal thread, wherein an intersection P between a root and a clearance flank of the thread is, set such that a first engaging rate ρ1 exceeds 50%, the first engaging rate ρ1 being percentage of an actual engaging height H1 to the hole against a first thread height H2 from a crest of the thread to the intersection P, an intersection Q between the root and a pressure flank of the thread is set such that a second engaging rate ρ2 is smaller than the first engaging rate and is greater than or equal to 50%, the second engaging rate ρ2 being percentage of the actual engaging height H1 to the hole against a second thread height H3 from the crest of the thread to the intersection Q, and the root of the thread inclines downward toward a tip direction, extending from the intersection P to the intersection Q thus set. Further, the clearance flank and the pressure flank of the thread make a compound angle with each other.

### Effects of the Invention

According to the tapping screw of the present invention, the first engaging rate ρ1 and the second engaging rate ρ2 may be set according to the actual engaging height H1, and the root inclining downward toward the tip direction according to this setting is provided. Therefore, the internal thread is filled to the intersection P at an innermost portion of the clearance flank, and it is possible to obtain a high anti-loosening effect. On the other hand, regarding the pressure flank, the internal thread is also filled to the intersection Q at an innermost portion of the pressure flank, and it is possible to obtain a high pull-out resistance. An improvement in the anti-loosening effect and the pull-out resistance is highly effective for fastening of resin-molded components with low durability and strength.

### BRIEF DESCRIPTION OF THE DRAWINGS

FIG. 1 is an entire view of a tapping screw according to the present invention.

FIG. 2 is an enlarged sectional view of a main part of the tapping screw according to the present invention.

### EMBODIMENT OF THE INVENTION

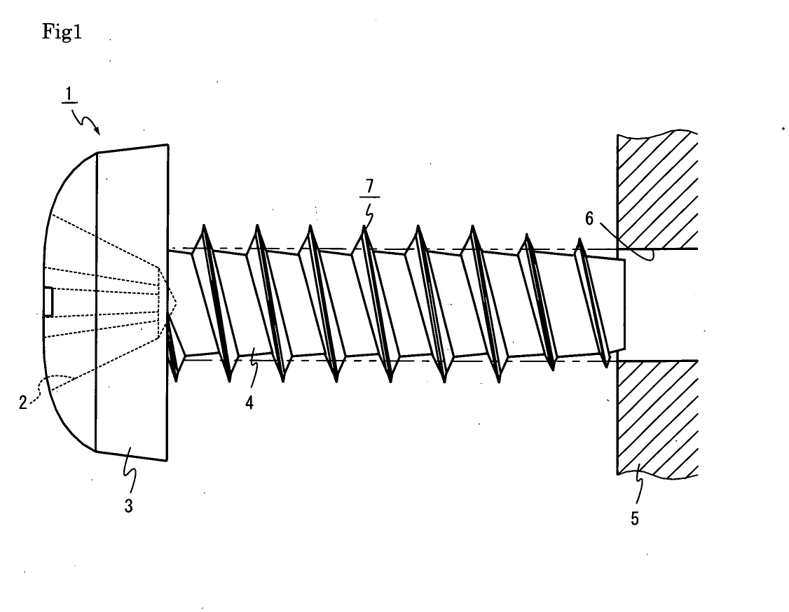

Hereinafter, an embodiment of the present invention is described with reference to the drawings. In FIG. 1, a reference numeral 1 represents a tapping screw including a head part 3 having a recess 2 with which a driver bit (not depicted) is to be engaged, and a shaft part 4 having a substantially triangular cross-section. The tapping screw 1 is inserted into a hole 6 that is previously formed in a workpiece 5 made of resin so as to have a predetermined dimension Φ, and causes a thread 7 formed around a surface of the shaft part 4 to get into a peripheral wall of the hole 6 by tightening torque applied to the screw, and is screwed into the hole while forming an internal thread.

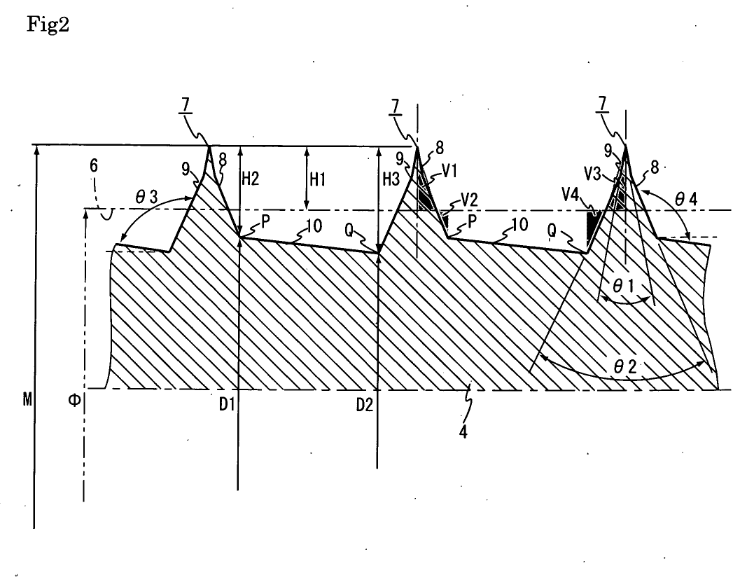

FIG. 2 illustrates a longitudinal section of the shaft part 4. As illustrated in FIG. 2, a clearance flank 8 and a pressure flank 9 of the thread 7 make a compound angle with each other, and a crest angle θ1 and a base angle θ2 are set to 20° and 40°, respectively. Such a configuration absorbs a stress that acts on the workpiece 5 when the internal thread is formed, prevents the workpiece 5 from cracking, and realizes smooth formation of the internal thread.

Each of the both flanks 8 and 9 of the thread 7 is connected to a root 10 so as to connect adjacent parts of the thread 7. An outer diameter D1 of the shaft part 4 at an intersection P between the root 10 and the clearance flank 8 is set to be larger than an outer diameter D2 of the shaft part 4 at an intersection Q between the root 10 and the pressure flank 9 (D1>D2), that is, the root 10 is provided so as to incline downward toward a tip direction. With this, according to the tapping screw 1 of the present invention, an angle θ3 between the root 10 and the pressure flank 9 is smaller and an angle θ4 between the root 10 and the clearance flank 8 are larger than those of a horizontal root of a common tapping screw, and therefore collapsing strength of the thread against an axial force acting toward a tip of the screw increases.

Here, according to the tapping screw 1 of the present invention, a first engaging rate ρ1, which is percentage of an actual engaging height H1 to a hole Φ against a first thread height H2 from a crest of the thread 7 to the intersection P, is defined as expressed by the following equation 1.

ρ1=(H1/H2)×100 [%] (Equation 1)

On the other hand, a second engaging rate ρ2, which is percentage of the actual engaging height Hl to the hole ρ2, against a second thread height H3 from the crest of the thread 7 to the intersection Q, is defined as expressed by the following equation 2.

ρ2=(H1/H3)×100 [%] (Equation 2)

Then, the first engaging rate ρ1 and the second engaging rate are respectively set to be within the following ranges.

ρ1>50% (Condition 1)

ρ1>ρ2≧50% (Condition 2)

Further, a hole diameter Φ of the tapping screw is to be determined in relation to workability, fastening strength, and thickness of the workpiece. As one example, in the tapping screw 1 of the present invention, as the hole diameter Φ is set to be roughly 70% of a nominal diameter M, the hole diameter Φ is equal to 2.1 [mm] for a tapping screw where the nominal diameter M is equal to 3.0 [mm] . Therefore, the actual engaging height H1, the first thread height H2 at the intersection P, and the second thread height H3 at the intersection Q are respectively represented by the following equations 3, 4, and 5 using the hole diameter Φ, the nominal diameter M, the diameter D1 at the root at the intersection P, and the diameter D2 at the root at the intersection Q.

H1=(M−Φ)×0.5 [mm] (Equation 3)

H2=(M−D1)×0.5 [mm] (Equation 4)

H3=(M−D2)×0.5 [mm] (Equation 5)

Therefore, under the condition 1 described above, a setting range of D1 is in the following relation by substituting the equations 3 and 4.

D1>1.2 [mm] (where D1≦Φ)

Thus, D1 is set within this range. For example, when D1 is set to be 1.6 mm, the first engaging rate ρ1 becomes 64%.

On the other hand, a setting range of the second engaging rate ρ2 is in the following relation under the condition 2 and where ρ1=64%.

64%>ρ2≧50%

Therefore, by substituting the equations 3 and 5, a setting range of D2 is in the following relation.

1.5>D2≧1.2 [mm]

Thus, D2 is set within this range. For example, when D2 is set to be 1.4 mm, the second engaging rate ρ2 becomes 56%.

According to the tapping screw of the present invention, by satisfying the condition 1, a cut-in volume V1 (thick shaded part) of the thread 7 at the clearance flank 8 becomes greater than a volume V2 (thinly shaded part) from the hole 6 to the intersection P, and therefore the plastically deformed internal thread flows to the intersection P. With this, a portion around a part at the intersection P where the diameter of the shaft part 4 is the largest is filled with the internal thread, and therefore it is possible to obtain a high anti-loosening effect.

On the other hand, by satisfying the condition 2, a cut-in volume V3 (thick shaded part) of the thread 7 at the pressure flank 9 becomes greater than a volume V4 (thinly shaded part) from the hole 6 to the intersection Q, and therefore the plastically deformed internal thread flows to the intersection Q. In addition, by the condition 2, the pressure flank 9 is set to be larger than the clearance flank 8. As the internal thread flows to the intersection Q, the pressure flank 9 that is a surface pressing the internal thread when an axial force is generated is entirely covered by the internal thread, and therefore it is possible to obtain a high pull-out resistance.

Further, as a synergistic effect of the high anti-loosening effect and the high pull-out resistance, it is possible to ensure the anti-loosening effect and the pull-out resistance even if pitch of the thread 7 is set to be relatively rough. It should be noted that by making the shape of the cross-section of the shaft part 4 substantially triangular, a gap is provided between the shaft part 4 and its imaginary circumscribed circle and the internal thread may flow into the gap, and therefore the internal thread filling the volumes V2 and V4 may not become'excessive and it is possible to stabilize tightening torque.

### DESCRIPTION OF REFERENCE SIGNS

1: Tapping screw

2: Recess

3: Head part

4: Shaft part

5: Workpiece

6: Hole

7: Thread

8: Clearance flank

9: Pressure flank

10: Root

1. A tapping screw comprising:
a shaft part having a thread therearound and configured to be screwed into a hole formed in a workpiece while forming an internal thread, wherein
an intersection P between a root and a clearance flank of the thread is set such that a first engaging rate ρ1 exceeds 50%, the first engaging rate ρ1 being percentage of an actual engaging height H1 to the hole'against a first thread height H2 from a crest of the thread to the intersection P,
an intersection Q between the root and a pressure flank of the thread is set such that a second engaging rate ρ2 is smaller than the first engaging rate and is greater than or equal to 50%, the second engaging'rate ρ2 being percentage of the actual engaging height H1 to the hole against a second thread height H3 from the crest of the thread to the intersection Q, and
the root of the thread inclines downward toward a tip direction, extending from the intersection P to the intersection Q thus set.

2. The tapping screw according to claim 1, wherein the clearance flank and the pressure flank of the thread make a compound angle with each other.
